(19) United States
(12) Patent Application Publication
(10) Pub. No.: US 2009/0098365 A1
(43) Pub. Date: Apr. 16, 2009

(54) Nanocrystalline sintered bodies made from alpha aluminum oxide method for production and use thereof

(75) Inventor: Paul Moeltgen, Laufenburg (DE)

Correspondence Address: LAW OFFICES OF MARK A. GARZIA, P.C., 2058 CHICHESTER AVE, BOOTHWYN, PA, 19061, US

(73) Assignee: Center for Abrasives and Refractories Research & Developement C.A.R.R.D. GmbH, Villach (AT)

(21) Appl. No.: 11/988,961

(22) PCT Filed: Jul. 12, 2006
(86) PCT No.: PCT/EP2006/006818

§ 371 Date: Jan. 15, 2008

(30) Foreign Application Priority Data
Jul. 16, 2005 (DE) 10 2005 033 392.3

(51) Int. Cl. B32B 5/16; C01F 7/02; C04B 35/01; B28B 1/00; B28B 3/00; C09K 3/14

(52) U.S. Cl. 428/328; 423/625; 501/94; 264/681; 264/432; 264/434; 428/402; 51/309

(57) ABSTRACT

Nanocrystalline sintered bodies, and a method of making same, said sintered bodies based on a 95 to 100% content of alpha-aluminum oxide by weight, a Vickers hardness greater than or equal to 17.5 GPa, and a crystal structure where the average primary crystal size of the alpha-aluminum oxide is less than or equal to 100 nanometers.

The present invention relates to sintered bodies based on α-aluminum oxide with a 95 to 100 wt. % content of Al₂O₃, a relative sinter density of ≧97% of the theoretical density, and a Vickers hardness HV0.2 of ≧17.5 GPa, with a crystal structure where the average primary crystal size of the Al₂O₃ is ≦100 nm.

Materials with nanoscale structures are of great interest in construction, electrotechnology, optics, machine and plant construction, vehicle engineering, medical engineering, the paper industry, and many other branches of industry. Material scientists have determined that miniaturizing the structure of materials sometimes leads to drastic changes in the properties of these materials. Thus one expects, for example in the field of ceramics, to find nanostructured ceramic materials with extraordinary increases in hardness, durability, breaking strength, abrasion resistance, and other properties; these materials should open up completely new application areas in fields of the industries listed above.

In the last few years, many research teams have been working with so-called nanotechnology. Many methods have already been discovered for producing nanoscale powders. Nanoscale oxidized powder for use in the area of ceramics can be produced with chemical synthesis, mechanical processes, or thermophysical processes.

Chemical synthesis uses simple, direct chemical reactions for conversion to powder. During this process, ultrafine particles arise due to manipulation of the nucleation or the seed growth. Often the powders are in so-called precursor forms that are close to the final product, and the final compound can be reached after only a thermal treatment. The chemical synthesis of oxidized nanopowders occurs through the known methods of hydroxide precipitation, synthesis through hydrolysis of metalorganic bonds, or through hydrothermal processes.

Through mechanical processes, fragments that are as small as possible are produced by repeatedly breaking a larger piece. The sizes of some of the particles made through this process are in the range of 5 to 100 nm, but this process is unsuited to the production of oxidized nanoscale ceramic powders, because it requires a very long grinding time in order to reach these grain sizes, the phase composition is usually not precisely defined, and the grain abrasion leads to impurities in the products.

Important processes for producing nanoscale oxidized ceramic powders are the so-called thermophysical methods, which depend on the addition of thermal energy to the resulting solid, liquid, or gaseous compounds, from which, for example, an oversaturated vapor is then formed; during this process, the nanocrystalline particles condense due to the release of the solvent. The thermal activation can occur, for example, due to combustion in flames, plasma vaporization, laser vaporization, microwaves, spray pyrolysis, or other similar processes.

In spray pyrolysis methods, the reactants are, for example, sprayed and dissipated in an oxyhydrogen flame. A common disadvantage of these processes is the relatively short dwell times in the flame, which lead to the appearance of transitional modifications. According to the principle of plasma synthesis, the products are vaporized in a hot plasma that is up to 6000 K. As the plasma cools, the nanoparticles are formed from the gas-vapor mixture. A disadvantage of this process is that the powders often agglomerate, with very hard agglomerates, such that the powder itself has a wide variety of particle sizes. The agglomerates can only be broken again with great technical effort, which, of course, strongly reduces the applications of such powders. By using the so-called hot wall reactor, the CVR process, the reactants are vaporized and brought to a reaction with defined flows in the reactor. This method also primarily produces agglomerates.

One of the most important raw materials in the field of ceramics is α-aluminum oxide, due to its physical and chemical properties. Many of the processes described above, therefore, have been previously used in order to produce nanocrystalline α-aluminum oxide powder.

EP 0 355 481 A1 describes the production of α-aluminum oxide with an average particle size of 0.1 to 0.2 μm and a concentration of more than 50% α-aluminum oxide, with γ-aluminum oxide being thermally treated in a flame. The γ-aluminum oxide used here may be prepared in a pyrogenic way, flame hydrolytically, from aluminum chloride.

EP 0 554 908 A1 describes the production of nanoscale α-aluminum oxide powders. In this work, a boehmite gel with finely milled silicon oxide dopes as a crystal growth inhibitor and then undergoes a thermal treatment for conversion to α-aluminum oxide. The production of ultrafine a-aluminum oxide powders and the production of finely milled solid ceramics is described in the “Journal of Materials Science,” 29 (1994), 5664-5672. The powder discussed in this article is first converted into a hydrate powder by means of hydroxide precipitation in the presence of α-aluminum oxide seeds and ammonium nitrate; the hydroxide powder is then converted into α-aluminum oxide in a thermal reaction. The particle size of the resulting α-aluminum oxide is 200 nm.

The production of nanocrystalline α-aluminum oxide powder from an aqueous solution of aluminum nitrate in the presence of sucrose is described in the “Journal of the American Ceramic Society” 84 (10), 2421-23 (2001). The result here is a porous nanocrystalline α-aluminum oxide with a specific surface area of more than 190 m²/g and an average pore size of between 80 and 25 nm. In addition, the preparation of nanocrystalline α-aluminum oxide powder through pyrolysis of organic complex bonds of aluminum with tri-ethanolamine is described in the “Journal of the American Ceramic Society” 84 (12), 2849-52 (2001). The average particle size was given as 25 nm.

The synthesis of nanocrystalline α-aluminum oxide powder from ammonium aluminum carbonate hydroxide is described in the “Journal of the American Ceramic Society” 85 (8), 1321-25 (2003). This process produces α-aluminum oxide powder with an average particle size between 150 and 30 nm. Many other processes for the production of finely milled α-aluminum oxide are known, many of which are not suitable for large-scale production or lead to products with unsatisfactory characteristics, so that the finest grain α-aluminum oxide powder that is currently available on the market in large quantities has an average particle size of approximately 0.1 to 0.3 μm; the formation of agglomerates from smaller crystallites is the primary reason for the formation of these relatively large particles.

Overall, the formation of hard and nearly indestructible agglomerates is one of the largest problems during the preparation and processing of nanoscale α-aluminum oxide powders.

The so-called “sol gel process” offers one approach to avoiding these problems, in which boehmite particles with an average diameter of approximately 20 nm are colloidally dissolved in an acidic, aqueous solvent and converted into a gel, which is then dried, calcined, and sintered. By adding α-aluminum oxide seeds at the same time, it is possible to reduce the sinter temperature needed for the condensation to approximately 1200 to 1300° C. and thereby to mostly suppress crystal growth during sintering. In this way, ceramic compounds can be produced, that have a crystalline structure such that the aluminum oxide crystals have an average particle diameter of 0.2 to 0.4 μm. One disadvantage of this process is the enormous reduction in volume during the transformation of the gel to the finished sintered product, such that it is nearly impossible to use this process on a large scale to produce hard and dense molds. This process, however, has proven itself for the production of sintered abrasive grains because these sorts of ceramic molds do not stringently demand a particular shape and size and abrasive grains with a grain size of less than 6 mm can be used in nearly all applications independent of their forms and sizes.

EP 0 152 768 B1 discloses abrasive grains that can be produced using the sol-gel technique at sinter temperatures of approximately 1400° C. Crystal seeds are added as a sintering aid. Similar processes and materials are described in EP 0 024 099 A1, DE 3 219 607 A1, U.S. Pat. No. 4,518,397 A, U.S. Pat. No. 4,574,003 A, U.S. Pat. No. 4,623,364 A, EP 0 168 606 A1, EP 0 200 487 A1, EP 0 228 856 A1, EP 0 209 084 A1 and EP 0 263 810 A1. All of these patents describe a sol-gel process, starting from finely dispersed aluminum oxide monohydrate of the boehmite type.

The condensation of the materials requires sinter temperatures in the range of 1200 to 1500° C. In order to limit the crystal growth at such high temperatures, crystal growth inhibitors, sinter additives, or crystal seeds are added. Although nanoscale boehmite is introduced as a precursor and the particles are uniformly distributed in a homogeneous aqueous suspension, it is still not possible, despite all these measures, to reduce the crystal size in the sintered product significantly further than the 0.2 to 0.4 μm mentioned above. One of the finest structures for an abrasive grain prepared using the sol-gel technique is described in EP 0 408 771 B 1: starting with boehmite and adding especially fine α-aluminum oxide seeds and a special sintering process, hard and dense abrasive grains with good structural properties can be prepared, which have an average particle diameter of up to 0.12 μm. A fine structure of this type can only be produced using much longer sintering times and a precisely defined sintering process. These conditions make this process unsuitable for cost effective, large-scale production.

In general, the sol-gel process has the disadvantage that relatively expensive boehmite must be used as a precursor, which is prepared from aluminum alcoholates using hydrolysis. A further disadvantage of the process is that it requires relatively dilute solutions. Therefore, a great deal of water must be evaporated during the subsequent drying, calcination, and sintering, which requires a correspondingly large amount of energy. In addition, the boehmite used in the sol-gel process must be dissolved in a strongly acidic solvent, using nitric acid as the acid; these nitric compounds are then released again in the form of nitric gases during the calcination and must be recaptured with appropriate technical measures in order to avoid harming the environment.

In order to avoid these disadvantages of the sol-gel process, researchers have tried to produce a microcrystalline sintered corundum ceramic starting directly from α-aluminum oxide using known technologies, such as slip casting, dry injection, extrusion, or other techniques. EP 0 725 045 B1 describes a process for the production of sintered α-aluminum oxide molds, where a relatively inexpensive α-aluminum oxide powder with an average seed size under 3 μm is used as the precursor and is ground to a slip with a particle size under 1 μm. Using spray drying, the slip is worked into an easily dispersible spray granulate, which is then pressed into a green body with a density of ≧60% of the theoretical density. The green body is subjected to a shock sintering at temperatures in the range of 1300 to 1550° C.; preferably, the particles are subjected to the maximum temperatures, which are necessary for the condensation, for only a few seconds, so that the crystal growth during the sintering can be mostly suppressed. Thus, it is possible to avoid crystal growth during the sintering with this process, although the structure of the sintering mold is naturally determined by the particle size of the inserted precursor powder, which was prepared by grinding: a this technique that has intrinsic limits. Using this method, it is not possible to cost effectively produce an α-aluminum oxide powder that is comparable to the results achieved with the sol-gel technique. Powders produced cost effectively with this method have an average primary crystal size of approximately 0.4 μm to 0.6 μm.

The process described in DE 198 09 679 A1 is another conventional ceramics technique, in which a polycrystalline sintered ceramic grinding material is prepared using unpressurized flat slip casting. After the outgassing, drying, and milling of the cast coating into an intermediate product and the sintering of the intermediate product, an abrasive grain with an average grain size of ≦0.8 μm is produced. The sizes of the crystals produced with this method are clearly larger than sol-gel corundums. Experience has shown, however, that the grinding power is correlated with the crystal size and specifically that it is inversely proportional to the crystal size. One would not expect a power comparable to the sol-gel corundum from the abrasive grain prepared according to DE 198 09 679 A1. A further disadvantage of the process described in DE 198 09 679 A1 is that relatively expensive raw materials must be used to achieve even a relatively coarse structure.

EP 0 756 586 B1 describes an abrasive grain with an average structure of 0.4 μm (example 2). In order to achieve a structure approximately equal to one prepared with the sol-gel corundum, an alumina with an average particle diameter of 0.12 μm must be added, from which a suspension must be prepared that is then gradually dehydrated and finally injected into molds. These molds are then sintered, unpressurized, at 1350° C. The disadvantages of this process are, first, that a crystal growth occurs during the sintering and an abrasive grain with an average structure size of 0.4 μm is still noticeably coarser than a conventional sol-gel corundum, and, second, that very expensive α-aluminum oxide powder must be added in order to achieve this result. Therefore, the process described above is unsuitable for the cost effective production of a sintered corundum.

Thus, there is still a demand for a cost-effective and high-performance polycrystalline fine grain sintered corundum based on α-Al₂O₃, which has a better price to performance than sol-gel corundums.

The object of the invention, therefore, is to make available a sintered body based on α-aluminum oxide, which does not have the disadvantages of the prior art, as described above.

The object is attained with a sintered body based on α-aluminum oxide with the characteristics give in claim 1.

Further embodiments and embodiments of the inventor's applications may be found in the subclaims.

The attainment of the object may be broken down into two steps. In the first step, a sufficiently cost-effective raw material with an appropriately fine crystalline structure is found, which is then prepared into the nanocrystalline sintered body.

Given that the work in recent years has concentrated primarily on the development of abrasive grains using the sol-gel process and there have been no significant and ground breaking improvements with regards to structure in the past 20 years since the above-mentioned patent EP 0 408 771 B1, the work in the context of the present invention has concentrated on the search for a cost-effective nanoscale α-aluminum oxide powder that may be prepared into a hard and dense nanoscale aluminum oxide ceramic. As part of the current work, a large number of commercially available α-aluminum oxide nanopowders were tested. None of the powders could meet the criteria for an effective material (price, workability, and phase purity), so an appropriate raw material had to be developed first.

While working on this invention, it was unexpectedly discovered that completely converting basic aluminum chloride into α-aluminum oxide with a particle size of 20 to 100 nm can be accomplished in the presence of crystal seeds at a relatively low temperature within a few minutes.

Basic aluminum chlorides (aluminum chlorohydrates) with the general chemical formula Al₂(OH)ₙCl_{z}, where n is a number between 2.5 and 5.5 and z is a number between 3.5 and 0.5 such that the sum of n+z always equals 6, have applications in a wide variety of areas. For example, they are used as active ingredients in cosmetic preparations such as antiperspirants or astringents. Their uses also include making textiles water-resistant and water purification. They are also used in fire-resistant materials, in inorganic fabrics, as well as in the production of catalysts with an aluminum oxide base. Processes for the preparation of basic aluminum chloride are described in DE 2 309 610 A, DE 1 567 470 A, DE 1 102 713 B, DE 2 518 414, and DE 2 713 236 B2. In the framework of the current invention, a basic aluminum chloride was added, which was produced by converting aqueous solutions of highly basic aluminum chloride with metallic aluminum in the presence of an activator. During the production, the basic aluminum chloride precipitates from the diluted aqueous solution.

During the production of the raw material for the sintered bodies based on α-aluminum oxide according to the invention, the suspension that precipitates during the production of the basic aluminum chloride is seeded with crystallization seeds. When doing so, it is preferable to add ultrafine α-aluminum oxide crystallites, which were produced by first wet grinding the α-aluminum oxide with aluminum oxide balls in an attritor mill and then separating the large particles with a centrifuge. After the large particles are extracted into a separate area, the particle size of the α-aluminum oxide particles remaining in the suspension is less than 100 nm. These α-aluminum oxide particles are created in the form of a suspension of the basic aluminum chloride in a quantity between 0.5 and 5 wt. %, preferably 2 wt. %, based on the solids content of the α-aluminum oxide in the final product. Besides aluminum oxide, other crystal seeds that have structure similar to corundums, such as Fe₂O₃, may also be added.

The suspension is next evaporated until it is dehydrated, and then it is subjected to a thermal treatment to convert the basic aluminum chloride into α-aluminum oxide. Using DTA-curves, it can be shown that the transformation temperature required to produce α-aluminum oxide using the thermal treatment of the basic aluminum chloride that was dried and seeded may be lowered by approximately 170° C., from about 1140° C. to about 970° C., due to the addition of the seeds. Thus, it is possible to achieve a complete conversion to α-aluminum oxide at temperatures under 1150° C. During this transformation, large amounts of HCl and water are released, which must be captured with appropriate scrubbers.

Surprisingly, the particle size of the resulting product is nearly independent of the type of thermal treatment. Thus, α-aluminum oxide particles with a particle size in the range of 20 to 100 nm can be achieved with complex thermophysical processes as well as with simple sintering in a muffle furnace. In all case, the agglomerates produced during this process are relatively easy to break back apart, such that a subsequent step with a conventional thermal treatment, for example, in a rotary kiln, is sufficient.

After the thermal treatment, the resulting product has a particle size between 20 and 100 nm and is in the form of soft, easily broken agglomerates. The thermal treatment requires less than 30 minutes. The formation of corundums starts occurring at 500° C. In order to maintain a high yield rate of the nano-α-Al₂O₃ and to keep the chlorine content low, it is preferable to work in a temperature range between 700 and 1100° C., especially between 1000 and 1100° C.

Optionally, the suspension of the basic aluminum chloride may be seeded with one or more oxide formers before the thermal treatment. The chlorides, oxychlorides, hydroxychlorides, and/or nitrates of one or more compounds from the following group: iron, copper, nickel, zinc, cobalt, strontium, barium, beryllium, magnesium, calcium, lithium, chromium, silicon, manganese, hafnium, zircon, titan, vanadium, gallium, niobium, boron, and/or the rare earth elements are particularly well suited as oxide formers. These materials are especially suited as additives for abrasive grains, and they can be homogeneously distributed as precursors and added to the reactants that form the end products. A thermal treatment is also required to convert these materials into oxides; some of these materials can also serve as sintering aids. The amount of oxides or oxide formers that are added is chosen so that the subsequent product has at most 5 wt. %, based on the α-aluminum oxide, of additional oxide.

As already mentioned above, the product is nearly independent of the type of thermal treatment; not only a rotary kiln, but any known method for thermal treatment may be used, including a fluidized bed reactor, a pusher-type kiln, a chamber kiln, a pipe kiln, or a microwave oven.

As well as these conventional methods, one may of course also use other thermal methods that are common in the context of producing nanoparticles. The known thermophysical processes may also be used; in these processes, basic aluminum chloride is preferably placed in a suspension, from which an oversaturated vapor is then formed, out of which nanocrystalline particles condense during the release of the solvent. Agglomerates also form during this process, but they are easily broken.

One disadvantage of all thermophysical processes, in comparison to using a conventional rotary kiln, is that only relatively small throughput can be achieved, which raises the cost of the product made with thermophysical processes. However, these processes are still of interest since they allow more precise control over the temperature than is possible in a rotary kiln, thereby allowing the quality of the nanopowder to be optimized as a side benefit.

The agglomerates produced after the thermal treatment are then disagglomerated in a subsequent step; any of the disagglomeration processes known in the field of ceramics may be used, since the agglomerates are easily broken in this case. Preferably, the disagglomeration is conducted as a wet or dry grinding; the wet grinding preferably occurs in an attritor, while the dry grinding preferably occurs in an air jet mill. Since the nanoparticles that are produced via grinding are extremely reactive, it is preferable to insert additives before or during the grinding in order to inhibit a renewed agglomeration of the nanoparticles.

Thus, it is especially advantageous to conduct the subsequent disagglomeration using the wet grinding method, during which a renewed agglomeration of the particles can easily be prevented by adding appropriate dispersion aids and stabilizers. During the wet grinding, it is also advantageous to add additional additives that accumulate on the surface of the particles and also prevent an agglomeration during the subsequent drying step. Waxes and stearates, preferably added in the form of nanoparticles, are appropriate materials to add at this step.

At this point in the process, additional oxidizing additives may also be added, which will then be homogenously mixed with the α-aluminum oxide powder during the grinding and disagglomeration. Preferably, one or more of the oxide compounds from the following group: iron, copper, nickel, zinc, cobalt, strontium, barium, beryllium, magnesium, calcium, lithium, chromium, silicon, manganese, hafnium, zircon, titan, vanadium, gallium, niobium, boron, and/or the rare earth elements may be added as an oxidizing additive. Here, the amount of additional oxide should be at most 5 wt. %, based on the amount of the α-aluminum oxide in the solid. This addition of oxides during the grinding can occur alternately or in parallel to the previously described addition of oxide formers in the suspension. During this process, however, one should ensure that the amount of oxide in the final product is not more than 5 wt. %, based on the solids content of the α-aluminum oxide.

Due to the nanopowder's proclivity for agglomeration, which was described above, and the measures necessary to avoid such an agglomeration in order to make the powder appropriately workable according to the invention, wet grinding is an especially suitable method for disagglomeration. Vibrating mills, attritors, ball mills, agitating ball mills, or similar devices are suitable for wet grinding. Using agitating ball mills has proven particularly advantageous. The grinding time depends on the solidity of the agglomerates, and the process according to the invention usually requires between two and six hours. The wet grinding or disagglomeration is preferably conducted in an aqueous medium, although alcoholic or other organic solutions may also be used.

If wet grinding is used for the disagglomeration, then the subsequent processing of the disagglomerated product may, in principle, be conducted in two ways. The nanopowder located in suspension can be directly processed into the green body with appropriate ceramic molding processes, or, alternatively, a drying process can be conducted and then the dried powder can subsequently be processed into the green body.

If the suspension is directly processed, then slip casting and electrophoretic precipitation should be strongly considered as ceramic molding processes. However, it is also possible to dry the suspension in which the nanonpowder is nearly homogenously distributed and thereby to use the nanopowder's proclivity for forming agglomerates. During drying, a compact and solid green body precipitates, which may be subsequently processed. Similar green bodies are produced using slip casting and electrophoretic precipitation.

Another interesting process for directly processing the suspension is spray granulation, in which the suspension is mixed with a binding agent and directly sprayed into solid granulates.

If a higher density in the green body is desired, then one can revert to molding processes, which are based on the insertion of powders. In the current application of disagglomeration using wet grinding, this means that the suspension is subsequently dried and then the dried powder must be processed. All known drying processes may be used for drying the suspension, although it is especially advantageous to use spray drying, in which the powder precipitates in the form of so-called spray granulates after the drying. Whatever drying process is used with the suspension, care must be taken to avoid the formation of hard agglomerates; this can be accomplished, for example, by adding appropriate additives to the suspension.

The compaction and processing of the powder can be accomplished using all the molding processes known in the field of ceramics. For example, without limiting the possibilities, the following may be used: slip casting, cold isostatic pressing, hot pressing, hot isostatic pressing, centrifugal separation, uniaxial pressing, injection molding, and extrusion. It is especially advantageous, particularly when producing abrasive grains, to make briquettes by using a compactor. By selecting the compactor rolls appropriately, the form and size of the resulting pellets may largely be fit to their later application as abrasive grains. Using a compactor, it is possible to make green bodies with extremely high green densities, which makes the subsequent sintering easier.

Before the sintering, regardless of which molding process creates the green bodies, it is preferable to mill the green bodies to a particle size that is on the order of the usual grain size for abrasive grains and that can coat the desired abrasive grains. Since the coarsest abrasive grains have a maximum particle diameter of approximately 4 mm, the green bodies should preferably be milled to a grain size of 6 mm or less before the sintering.

In an especially advantageous embodiment of the present invention, the suspension is directly processed and spray granulation is used to dry the suspension of the disagglomerated powders; in this case, a subsequent milling is superfluous, because high-density spray granulates with a defined size can be achieved with this process, which makes an additional compaction and a subsequent milling of the spray granulate unnecessary. Spray granulates obtained in this way can be directly sintered. In order to produce an abrasive grain, the diameter of the spray granulates that precipitate as balls as a result of the production process must be selected to have an appropriate size, such that a subsequent milling of the sintered balls can achieve the desired grains with the corners and cutting edges necessary for an abrasive grain. Dense sintered balls produced in this way can also be used for special applications, such as for grinding balls.

The sintering of the milled green bodies occurs at temperatures between 1200° C. and 1500° C. It has proven to be preferable for the green bodies to achieve the temperature necessary for compaction as quickly as possible and then spend as little time as possible at the maximum of the sintering temperature range. Thus, any type of oven or sintering process that allows the green body to be heated with a sudden burst of heat is appropriate for the sintering. Preferably, directly or indirectly heated rotary kilns, hanging kilns, pusher-type kilns, fluidized bed reactors, or microwave sintering ovens are used. During the sintering, the amount of time spent in the hot zone should be less than 60 minutes, preferably less than 30 minutes, and ideally less than 15 minutes. The sintered bodies should reach the necessary sintering temperature in less than 60 seconds, preferably in less than 30 seconds, and ideally in less than 10 seconds.

Due to the homogeneous particle distribution in the green body, the rapid heating during the sintering, and the short duration of the heat, crystal growth during the sintering can be almost completely suppressed. Hard and dense sintered bodies are produced, and their crystalline structure is almost completely determined by the particle size of the precursors.

According to the invention, extremely fine precursors with particle sizes between 20 and 100 nm are used, so it is thus possible to achieve the desired sintered bodies that have a crystalline structure with an average primary crystal size of ≦100 nm.

In the following, the invention is further explained with figures and examples, where:

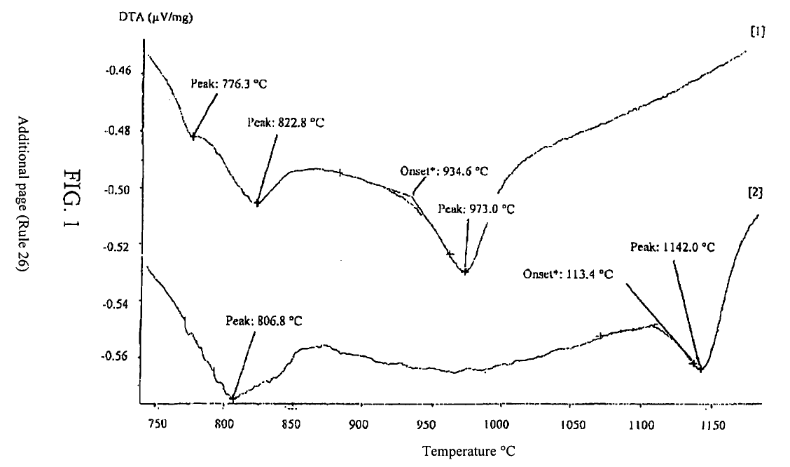

FIG. 1 shows a differential thermal analysis of the precursor with and without seeds,

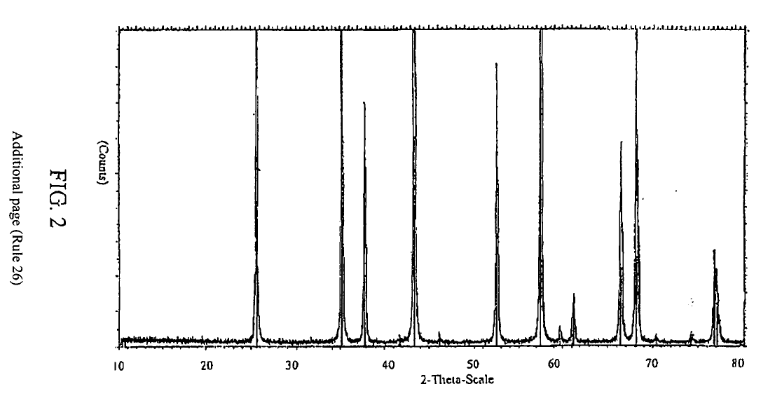

FIG. 2 shows a Roentgen diffractogram of the intermediate products after a temperature treatment at 1000° C., and

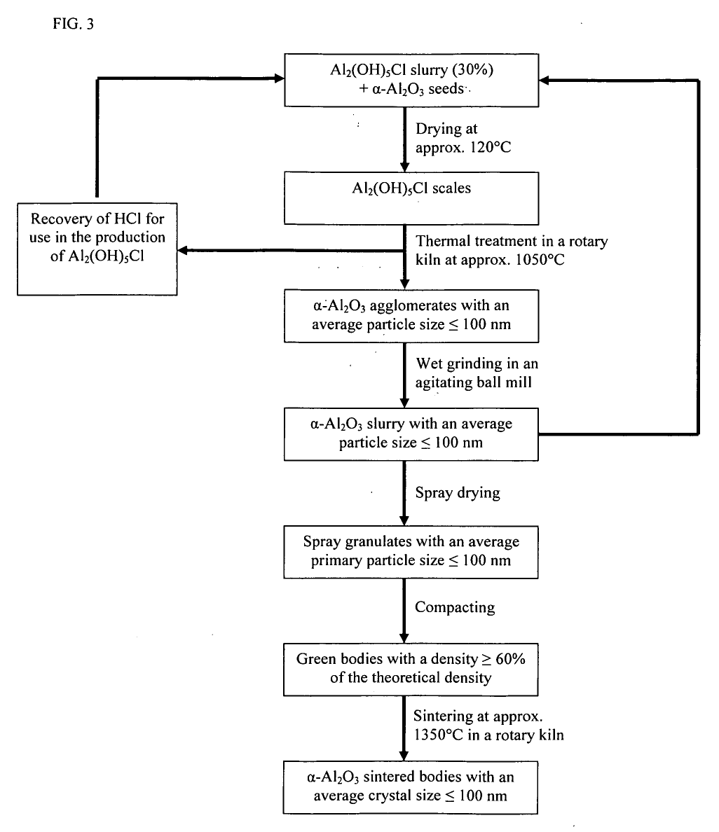

FIG. 3 shows a flow chart of the process.

FIG. 1 shows that the seeded precursor, the DTA curve marked with the number 1, has been fully converted to α-aluminum oxide at 973° C. This means that the addition of seeds has lowered the transformation temperature by approximately 170° C. in comparison to the unseeded material, which is shown in curve 2.

FIG. 2 shows a Roentgen diffractogram of a powder that was produced starting from basic aluminum oxide that was seeded with 2% crystal seeds and underwent a temperature treatment at 1000° C. Clearly, the basic aluminum oxide has been fully transformed into α-aluminum oxide. No impurities from any kind of intermediate aluminas can be seen.

FIG. 3 is a flow chart providing a sample overview of the production process for a sintered body according to the invention with an average crystallite size of less than 100 nm. The concrete process steps given in this example refer to a preferred embodiment of the method of the invention, which is described in example 1, and should not be seen as limiting the invention.

As seen in FIG. 3, a slurry of basic aluminum chloride seeded with α-aluminum chloride seeds is dried with steam at about 120° C., using a drum dryer, for example. At this step in the process, the basic aluminum chloride precipitates in the form of scales, which subsequently undergo a thermal treatment at 1050° C. in a rotary kiln. During the thermal treatment, the basic aluminum chloride is milled, producing α-aluminum oxide as well as a great deal of hydrochloric acid, which is captured and reused for the production of basic aluminum chloride. In this step, approximately 470 g of α-aluminum oxide and 530 g of hydrochloric acid are produced for every kilogram of dried Al₂(OH)₅Cl scales. Approximately 50% of the weight of the Al₂(OH)₅Cl scales is due to the chemically bonded water and the crystal water that was taken up, which will be evaporated during the thermal treatment.

The α-aluminum oxide obtained after the thermal treatment consists of agglomerates. The average particle size of the α-aluminum oxide particles in the agglomerates is between 20 and 100 nm. The agglomerates themselves are relatively soft and can be disagglomerated, preferably with wet grinding in an agitating ball mill. After this step, an α-Al₂O₃ slurry is obtained, in which the particle size of the individual particles is between 20 and 100 nm. These particles are highly reactive, and it is preferable to add a dispersion aid or other additive during the wet grinding in order to prevent the agglomerates from reforming. The slurry is subsequently dried in a spray dryer, and spray granulates with an average primary particle size under 100 nm are produced.

Before the spray drying, it is preferable to add additives that accumulate on the surface of the individual particles and inhibit them from forming solid agglomerates. In this way, soft, easily dispersible spray granulates are produced, which can subsequently be condensed to green bodies.

In the flow chart shown here, the condensation occurs as a compacting step, which produces green bodies with a density that is clearly greater than 60% of the theoretical density.

The pellets obtained after the compacting are initially milled to a particle size of ≦6 mm and then sintered at 1350° C. in a rotary kiln. After the sintering, an α-Al₂O₃ sintered body with an average crystal size of ≦100 nm is obtained. In a subsequent classification step (milling or sifting), an abrasive grain is obtained, which is especially suitable for use in coated abrasive materials and bound abrasive materials.

In the following sections, the invention is further explained using examples; these examples relate to preferred and advantageous embodiments and are not intended as limitations on the invention.

### Example 1

A basic aluminum chloride with the trade name Locron® L, which is commercially available from Fa. Clariant Ag, Gersthofen (Germany), was used as the percursor for the production of nanocrystalline α-Al₂O₃. The basic aluminum chloride is sold as a 50% aqueous solution and has the chemical formula Al₂(OH)sCl×2-3 H₂O. Thus, the 50% aqueous solution of the aluminum chloride consists of approximately 23-24% Al₂O₃.

WSK300, an α-aluminum oxide from Fa. Treibacher Schleifmittel GmbH, Laufenburg (Germany), was used as the precursor for the α-Al₂O₃ seeds; it is sold as an easily dispersible spray granulate, with primary particles that have an average particle size of approximately 0.5 μm.

The WSK3000 underwent an approximately 3-hour wet grinding in an agitating ball mill. The resulting suspension was subsequently processed in a clarifying separator, which separated approximately 95% of the solids content using a centrifugal separation. The smallest particles remaining in the suspension had an average particle diameter of approximately 50 nm (measured with a raster electron microscope, Joel ISM 6400, with a 20,000× magnification), and they were added as seeds to the suspension of Locron® L at a proportion of 2 wt. %, based on the amount of Al₂O₃.

The suspension seeded in this way was dried using hot steam at a temperature of approximately 120° C. The dried basic aluminum chloride thereby precipitated in the form of scales, with an average diameter of approximately 6 mm.

The precipitated scales were subsequently subjected to a thermal treatment at 1050° C. for approximately 30 minutes in an indirectly heated electric rotary kiln that had been provided with an extractor fan; the basic aluminum chloride was thereby converted to α-Al₂O₃ due to the release of hydrochloric acid and water. The released hydrochloric acid, together with the water, was captured by a scrubber and prepared into a 31% hydrochloric acid solution; this solution, with aluminum metal, could then be converted back into basic aluminum chloride. While the dried and seeded Al₂(OH)₅Cl×2-3 H₂O was being placed in a rotary kiln, it was analyzed with a small probe of a differential thermoanalyzer; the results of this probe are plotted in FIG. 1.

The α-Al₂O₃ produced in the rotary kiln was roentgenographically measured, and it was determined that the all of the basic aluminum chloride was fully transformed into α-Al₂O₃. The Roentgen diffractogram of the probe is shown in FIG. 2.

After the treatment in the rotary kiln, the product was in the form of relatively soft agglomerates of α-Al₂O₃, which were then disagglomerated using a wet grinding in an agitating ball mill (Drais, PMC 25 TEX, Bühler GmbH) with a grinding duration of approximately 3 hours. To stabilize the suspension, a finely dispersed wax was added at the beginning of the grinding, which covered the surface of the nanoparticles during the grinding and thereby prevented the agglomerates from reforming.

The suspension obtained in this way, consisting of individual nanoparticles with an average particle diameter of approximately 60 nm, was dried using a spray dryer, forming very soft and loose spray agglomerates with an average agglomerate diameter of approximately 40 μm and an average primary particle diameter of 60 nm. The residual moisture in the spray agglomerate was approximately 2%.

Without the addition of additives, the spray agglomerate was subsequently briquetted using a compactor (CS 25, Hosokawa Bepex GmbH) into 50 mm long by 10 mm thick pellets that can be added as green bodies for the desired sintered bodies. The density of the green bodies was 72% of the theoretical thickness. The green bodies, therefore, had sufficient moisture to be milled to a particle size of less than 6 mm in a subsequent sintering step, so that the yield losses due to precipitates at this point were not too high for the later production of abrasive grains.

The green bodies were next sintered in a rotary kiln that was directly heated with gas at a temperature of 1350° C., spending approximately 20 minutes sintering in the rotary cylinder. The green bodies spend only a few seconds in the hottest zone (in the center of the flame), so that a type of shock sintering occurs; most crystal growth is thereby prevented.

The α-Al₂O₃ sintered bodies produced according to the invention with a maximum diameter of approximately 4 mm were then processed with sifting and milling into abrasive grains.

The abrasive grain, with a density of 99.3% of the theoretical density, a Vickers hardness HV_{0.2} of 2230 GPa, and a nanocrystalline crystal structure with an average primary grain size of 70 nm, was added to coated abrasive materials and bound abrasive materials and tested. The test results are summarized in tables 1 and 2 under examples 5 and 6.

### Example 2

The production of a suspension of basic aluminum chloride that had been seeded with seeds, the subsequent drying, and the thermal conversion to α-Al₂O₃ occurred as in example 1.

During the subsequent approximately 3-hour disagglomeration in an agitating ball mill, however, no stabilizer was added to the suspension. Instead, immediately after the end of the disagglomeration, the suspension was poured out to an approximately 6 mm thick layer, degassed in a vacuum drying chamber (for 5 hours at 200 mbar), and then dried at approximately 80° C. The dried material was pre-calcined at 500° C. for 30 minutes and then milled into abrasive grain-sized particles (6 mm and smaller). The subsequent sintering occurred in a rotary kiln as in example 1.

The abrasive grain produced in this way had a density of 98.8% of the theoretical density, a Vickers hardness HV_{0.2} of 2190 GPa, and an average primary grain size of 70 nm. As in example 1 above, example 2 was tested in coated abrasive materials and bound abrasive materials. The test results are summarized in tables 1 and 2 under examples 5 and 6.

### Example 3

The production of a suspension of basic aluminum chloride that had been seeded with seeds, the subsequent drying, and the thermal conversion to α-Al₂O₃ occurred as in example 1.

During the subsequent approximately 3-hour disagglomeration in an agitating ball mill, a polyacrylic acid was added to the suspension as a dispersion aid for stabilization. The suspension with a solids content of approximately 30% was then mixed with a 10% aqueous solution of polyvinyl alcohol (Mowiol 8-88, Kuraray Specialties Europe GmbH, Frankfurt, Germany) as a binding agent, in an amount of 0.05 wt. %, based on the amount of Al₂O₃.

Next, the suspension was granulated in a fluidized bed spray granulator (AGT 150, Glatt GmbH, Binzen, Germany) at an air entry temperature of 95° C., a layer temperature of 45° C., a spray pressure of 3 bar, and a spray rate of 70 g/min. For the seed formation, a fine granulate fraction with an average granulate size of 0.2 mm is used, which was previously produced in a fluidized bed granulator using an in situ seed formation. The separation of the desired granulates with an average granulate diameter of 4 mm is accomplished with a zig-zag sifter, which was driven with 9 Nm³/h air. The density of the granulates was about 75% of the theoretical density and the residual moisture was less than 1%. The granulates were calcined at about 500° C., then milled to the size of abrasive grains, and finally sintered in a rotary kiln at 1350° C., as in example 1.

The abrasive grain produced in this way had a density of 98.6% of the theoretical density, a Vickers hardness HV_{0.2} of 2210 GPa, and an average primary grain size of 60 nm. As in example 1 above, example 3 was tested in coated abrasive materials and bound abrasive materials. The test results are summarized in tables 1 and 2 under examples 4 and 5.

### Example 4

The production of a suspension of basic aluminum chloride that had been seeded with seeds, the subsequent drying, and the thermal conversion to α-Al₂O₃ occurred as in example 1.

During the subsequent approximately 3-hour disagglomeration in an agitating ball mill, an ammonium salt of polyacrylic acid was added to the suspension as a dispersion aid for stabilization. The suspension was then mixed with a 20% solution of polyvinyl alcohol (Celvol 502, Celanese Chemicals, Frankfurt am Main) as a binding agent, in an amount of 0.05 wt. %, based on the amount of Al₂O₃.

Next, the suspension was dried in a vacuum mixer (R08W VAC, Maschinenfabrik Gustav Eirich) until it had a paste-like consistency. The first mixer setting was 700 mBar, 110° C., with unidirectional flow. Then the mixer was reversed to the other direction and set to grate at 600 to 1600 l/min, 120° C., and 850 mBar. The density of the granulates was 75% of the theoretical density, and the residual moisture was 2%. The granulates were milled to abrasive grains and sintered in a rotary kiln at 1350° C., as in example 1.

The abrasive grain produced in this way had a density of 99.1% of the theoretical density, a Vickers hardness HV_{0.2} of 2190 GPa, and an average primary grain size of 65 nm. As in the previous examples, example 4 was tested in coated abrasive materials and bound abrasive materials. The test results are summarized in tables 1 and 2 under examples 5 and 6.

### Example 5

### Belt Test

Abrasive belts were produced using a P36 granulation with the abrasive grains produced according to examples 1 to 4 as well as with a commercially available sol-gel corundum (Cerpass XTL, Saint Gobain Industrial Ceramics) and a commercially available eutectic zirconium corundum (ZK40, Trebacher Schleifmittel GmbH, Laufenburg, Germany) as comparative examples. The material 42CrMo4 was processed with the belts at a pressure of 70 N with an abrasive time of 60 minutes.

The erosion performance and the corresponding abrasive performance percentages are summarized in table 1.

TABLE 1

| | | Stock | |
|---|---|---|---|
| Abrasive characteristics | Type of | removal | Abrasive |
| (Belt grinding) | abrasive grain | (g) | performance (%) |
| Material: 42CrMo4, | Sol-gel | 4248 | 100 |
| DIN 1.7225 | corundum | | |
| (Heat treatable steel) | Eutectic | 3356 | 79 |
| Granulation: P36 | zirconium | | |
| Pressure: 70 N | corundum | | |
| Granulation time: 60 min | Example 1 | 5645 | 133 |
| Velocity: 2500 rpm - | Example 2 | 5267 | 124 |
| 33 m/s | Example 3 | 5710 | 134 |
| | Example 4 | 5437 | 128 |

### Example 6

### Disc Test

An abrasive test for abrasive discs was conducted with the abrasive grains produced in examples 1 to 3. For comparison, the commercially available sol-gel corundum Cerpass XTL (Saint Gobain Industrial Ceramics) and Cubitron 321 (3M, Abrasive Systems Division) were also used. To produce the abrasive discs, the above mentioned sintered corundums were mixed in the F60 granulation with premium white fused alumina at a ratio of 30:70, sintered corundum:premium white fused alumina, and placed in a ceramically bonded abrasive disc.

The material 16MnCr5 was processed. After the test, the G-factor (the ratio of erosion to disc wear) was determined.

The G-factors and the corresponding abrasive performance percentages are summarized in table 2.

TABLE 2

| Abrasive characteristics | Type of | | Abrasive |
|---|---|---|---|
| (Flat grinding) | abrasive grain | G-factor | performance (%) |
| Material: 16MnCr5, | Cubitron 321 | 178 | 100 |
| DIN 1.17131 | Cerpass | 164 | 92 |
| (Heat treatable steel) | Example 1 | 276 | 155 |
| Granulation: F60 | Example 2 | 233 | 131 |
| Infeed: 0.02 mm | Example 3 | 245 | 138 |
| Velocity: 2600 rpm - | Example 4 | 256 | 145 |
| 30 m/s | | | |
| Feed rate: 21 m/min | | | |
| Erosion surface: | | | |
| 20 mm × 10 mm | | | |

As can be clearly seen in the results of the abrasive tests, the abrasive grains produced according to the invention have better performance than the conventional abrasive grains currently available on the market. Since the production of the abrasive grains according to the invention can also be accomplished with a relatively inexpensive raw material, which can be transformed into α-Al₂O₃ nanoparticles without significant technical effort, the process according to the invention has succeeded in producing a cost-effective and high-performance polycrystalline sintered corundum with a more favorable price/performance ratio than the sol-gel corundums available on the market.

1. A sintered body based on α-Al₂O₃ with a 95 to 100 wt. % content of Al₂O₃, a relative sinter density of ≧97% of the theoretical density, and a Vickers hardness HV_{0.2} of ≧17.5 Gpa characterized in that the sintered body has a crystalline structure where the average primary crystal size of the Al₂O₃ crystals is ≦100 nm.

2. A sintered body according to claim 1, characterized in that the sintered body also has a maximum content of 5 wt. % of one or more compounds from the oxide groups of Fe, Cu, Ni, Zn, Co, Sr, Ba, Be, Mg, Ca, Li, Cr, Si, Mn, Hf, Zr, Ti, V, Ga, Nb, B, and/or the rare earth elements, based on the amount of Al₂O₃.

3. A sintered body according to claim 1 characterized in that this sintered body has a crystalline structure where the primary crystal size of the Al₂O₃ crystals is ≦100 μm.

4. A sintered body according to claim 1, characterized in that this sintered body is an abrasive grain.

5. A method for the production of a sintered bodies according to claim 1, characterized in that the process includes the following steps:
a) manufacture of a nanocrystalline α-Al₂O₃ powder with an average particle size of ≦100nm,
b) condensation of the α-Al₂O₃ powder using a ceramic molding process into a green body with a density of ≧60% of the theoretical density, and
c) sintering of the green body in a temperature range between 1200 and 1500° C.

6. The method according to claim 5 characterized in that the precursor for the α-Al₂O₃ powder is basic aluminum chloride with the chemical formula Al₂(OH)ₙCl_{z}, where n is a number between 2.5 and 5.5 and z is a number between 3.5 and 0.5, such that the sum of n+z always equals 6.

7. The method according to claim 5 characterized in that the basic aluminum chloride in an aqueous solution is first seeded with finely dispersed crystal seeds, then dried, and then finally precipitated with a thermal treatment at temperatures under 1100° C.

8. The method according to claim 5 characterized in that finely dispersed α-Al₂O₃ seeds are used as crystal seeds.

9. The method according to claim 5 characterized in that the α-Al₂O₃ seeds that are added have an average particle size of less than 0.1 μm.

10. The method according to claim 5 characterized in that finely dispersed α-Fe₂O₃ is added as crystal seeds.

11. The method according to claim 5 characterized in that the precursor suspension contains one or more oxide formers along with the basic aluminum chloride.

12. The method according to claim 11 characterized in that one of the following is used as an oxide former: the chloride, oxychloride, hydrochloride, and/or nitrate of one or more compounds from the following group: Fe, Cu, Ni, Zn, Co, Sr, Ba, Be, Mg, Ca, Li, Cr, Si, Mn, Hf, Zr, Ti, V, Ga, Nb, B, and/or the rare earth elements.

13. The method according to claim 11 characterized in that the amount of oxide former used is at most 5 wt. %, calculated as oxide and based on the solids content of the Al₂O₃ in the final product.

14. The method according to claim 5 characterized in that the thermal treatment is a conventional sinter process, in which the suspension is first dried and then the dried product is sintered.

15. The method according to claim 14 characterized in that the sintering is conducted in a fluidized bed reactor, pusher-type kiln, chamber kiln, pipe kiln, rotary kiln, or microwave oven.

16. The method according to claim 5 characterized in that the thermal treatment is a thermophysical process, such as spray pyrolysis, plasma synthesis, or condensation in a hot-wall reactor, for example.

17. The method according to claim 5 characterized in that the nanoparticles agglomerated during the thermal treatment may be disagglomerated in a subsequent step by wet or dry grinding.

18. The method according to claim 17 characterized in that the disagglomeration is conducted as wet grinding in an attritor mill.

19. The method according to claim 5 characterized in that additives, such as press aids, sintering additives, binding agents, dispersion aids, and/or other additional materials are added to the nanocrystalline α-Al₂O₃ powder during the disagglomeration.

20. The method according to claim 5 characterized in that finely dispersed waxes and/or stearates are added to the nanocrystalline powder during the disagglomeration.

21. The method according to claim 5 characterized in that the suspension produced after the disagglomeration using wet grinding is dried using an arbitrary drying process, which produces a nanocrystalline powder based on α-Al₂O₃.

22. The method according to claim 21 characterized in that the drying is a spray drying.

23. The method according to claim 5 characterized in that the ceramic molding process is a slip casting, in which the slip of the nanocrystalline α-Al₂O₃ powder obtained using wet grinding flows by gravity into a container, where it is degassed and dried to a green body.

24. The method according to claim 5 characterized in that the ceramic molding process is a spray granulation, in which the suspension obtained using wet grinding is mixed with a binding agent and subsequently undergoes a spray granulation.

25. The method according to claim 5 characterized in that the ceramic molding process is an agglomeration, in which the suspension obtained using wet grinding is mixed with a binding agent and subsequently worked into granulates in a vacuum mixer.

26. The method according to claim 22 characterized in that the ceramic molding process is a powder press method, in which the nanocrystalline α-Al₂O₃ powder is pressed into a green body using a compactor.

27. The method according to claim 22 characterized in that the ceramic molding process is an extrusion method, in which the nanocrystalline α-Al₂O₃ powder is processed with at least a binding agent and a solution into an extrudable mass and is subsequently extruded to a green body.

28. The method according to claim 5 characterized in that the green bodies are milled to a particle diameter of ≦6 mm, subsequently sintered at a temperature range between 1200° C. and 1500° C., and then the sintered product is processed using additional milling and sifting into abrasive grains.

29. The method according to claim 5 characterized in that during the sintering, the green bodies are brought to the necessary sintering temperature in ≦60 seconds and the dwell time in the hot zone is ≦30 minutes.

30. The method according to claim 5 characterized in that the sintering is conducted in a rotary kiln.

31. Use of the sintered body according to claim 1 for the production of ceramic components, as a polishing agent, as matrix reinforcement for metallic films, as well as for the production of abrasive grains.

32. Use of the sintered body grains according to claim 1 for the production of bonded abrasives and coated abrasives, and additionally as an additive to raise the abrasion resistance of laminates.

33. A sintered body according to claim 2 characterized in that this sintered body has a crystalline structure where the primary crystal size of the Al₂O₃ crystals is ≦100 μm.

34. A sintered body according to claim to 33, characterized in that this sintered body is an abrasive grain.

35. A method for the production of a sintered bodies wherein said sintered body is based on α-Al₂O₃ with a 95 to 100 wt. % content of Al₂O₃, a relative sinter density of greater than or equal to 97% of the theoretical density, and a Vickers hardness HV_{0.2} of greater than or equal to 17.5 Gpa, the sintered body comprised of crystalline structure where the average primary crystal size of the Al₂O₃ crystals is less than or equal to 100 nm, and the sintered body is an abrasive grain, the method comprising the steps:
a) manufacturing a nanocrystalline α-Al₂O₃ powder with an average particle size of ≦100 nm,
b) condensation of the α-Al₂O₃ powder using a ceramic molding process into a green body with a density of ≧60% of the theoretical density, and
c) sintering of the green body in a temperature range between 1200 and 1500° C.

36. The method according to claim 35 characterized in that the precursor for the α-Al₂O₃ powder is basic aluminum chloride with the chemical formula Al₂(OH)ₙCl_{z}, where n is a number between 2.5 and 5.5 and z is a number between 3.5 and 0.5, such that the sum of n+z always equals 6.

37. The method according to claim 36 characterized in that the basic aluminum chloride in an aqueous solution is first seeded with finely dispersed crystal seeds, then dried, and then finally precipitated with a thermal treatment at temperatures under 1100° C.

38. The method according to claim 37 characterized in that finely dispersed α-Al₂O₃ seeds are used as crystal seeds.

39. The method according to claim 38 characterized in that the α-Al₂O₃ seeds that are added have an average particle size of less than 0.1 μm.

40. The method according to claim 37 characterized in that finely dispersed α-Fe₂O₃ is added as crystal seeds.

41. The method according to claim 40 characterized in that the precursor suspension contains one or more oxide formers along with the basic aluminum chloride.

42. The method according to claim 41 characterized in that one of the following is used as an oxide former: the chloride, oxychloride, hydrochloride, and/or nitrate of one or more compounds from the following group: Fe, Cu, Ni, Zn, Co, Sr, Ba, Be, Mg, Ca, Li, Cr, Si, Mn, Hf, Zr, Ti, V, Ga, Nb, B, and/or the rare earth elements.

43. The method according to claim 42 characterized in that the amount of oxide former used is at most 5 wt. %, calculated as oxide and based on the solids content of the Al₂O₃ in the final product.

44. The method according to claim 43 characterized in that the thermal treatment is a conventional sinter process, in which the suspension is first dried and then the dried product is sintered.

45. The method according to claim 44 characterized in that the sintering is conducted in a fluidized bed reactor, pusher-type kiln, chamber kiln, pipe kiln, rotary kiln, or microwave oven.

46. The method according to claim 43 characterized in that the thermal treatment is a thermophysical process, such as spray pyrolysis, plasma synthesis, or condensation in a hot-wall reactor, for example.

47. The method according to claim 46 characterized in that the nanoparticles agglomerated during the thermal treatment may be disagglomerated in a subsequent step by wet or dry grinding.

48. The method according to claim 47 characterized in that the disagglomeration is conducted as wet grinding in an attritor mill.

49. The method according to claim 48 characterized in that additives, such as press aids, sintering additives, binding agents, dispersion aids, and/or other additional materials are added to the nanocrystalline α-Al₂O₃ powder during the disagglomeration.

50. The method according to claim 49 characterized in that finely dispersed waxes and/or stearates are added to the nanocrystalline powder during the disagglomeration.

51. The method according to claim 50 characterized in that the suspension produced after the disagglomeration using wet grinding is dried using an arbitrary drying process, which produces a nanocrystalline powder based on α-Al₂O₃.

52. The method according to claim 51 characterized in that the drying is a spray drying.

53. The method according to claim 49 characterized in that the ceramic molding process is a slip casting, in which the slip of the nanocrystalline α-Al₂O₃ powder obtained using wet grinding flows by gravity into a container, where it is degassed and dried to a green body.

54. The method according to claim 49 characterized in that the ceramic molding process is a spray granulation, in which the suspension obtained using wet grinding is mixed with a binding agent and subsequently undergoes a spray granulation.

55. The method according to claim 49 characterized in that the ceramic molding process is an agglomeration, in which the suspension obtained using wet grinding is mixed with a binding agent and subsequently worked into granulates in a vacuum mixer.

56. The method according to claim 52 characterized in that the ceramic molding process is a powder press method, in which the nanocrystalline α-Al₂O₃ powder is pressed into a green body using a compactor.

57. The method according to claim 52 characterized in that the ceramic molding process is an extrusion method, in which the nanocrystalline α-Al₂O₃ powder is processed with at least a binding agent and a solution into an extrudable mass and is subsequently extruded to a green body.

58. The method according to claim 57 characterized in that the green bodies are milled to a particle diameter of ≦6 mm, subsequently sintered at a temperature range between 1200° C. and 1500° C., and then the sintered product is processed using additional milling and sifting into abrasive grains.

59. The method according to claim 58 characterized in that during the sintering, the green bodies are brought to the necessary sintering temperature in ≦60 seconds and the dwell time in the hot zone is ≦30 minutes.

60. The method according to claim 59 characterized in that the sintering is conducted in a rotary kiln.

61. A sintered body based on α-Al₂O₃ with a 95 to 100 wt. % content of Al₂O₃, a relative sinter density of greater than or equal to 97% of the theoretical density, and a Vickers hardness HV_{0.2} of greater than or equal to 17.5 Gpa, the sintered body comprised of crystalline structure where the average primary crystal size of the Al₂O₃ crystals is less than or equal to 100 nm, and the sintered body is an abrasive grain used for the production of ceramic components, as a polishing agent, as matrix reinforcement for metallic films, as well as for the production of abrasive grains.

62. A sintered body based on α-Al₂O₃ with a 95 to 100 wt. % content of Al₂O₃, a relative sinter density of greater than or equal to 97% of the theoretical density, and a Vickers hardness HV_{0.2} of greater than or equal to 17.5 Gpa, the sintered body comprised of crystalline structure where the average primary crystal size of the Al₂O₃ crystals is less than or equal to 100 nm, and the sintered body is an abrasive grain used for the production of bonded abrasives and coated abrasives, and additionally as an additive to raise the abrasion resistance of laminates.
